(19) United States
(12) Patent Application Publication
(10) Pub. No.: US 2004/0131137 A1
(43) Pub. Date: Jul. 8, 2004

(54) Method and device for radioactive decontamination of a surface located inside an hollow body

(76) Inventor: Alain Bernard, Ferriere La Grande (FR)

Correspondence Address: Morris Liss, Connolly Bove Lodge & Hutz, PO Box 19088, Washington, DC, 20036-3425, US

(21) Appl. No.: 10/466,277

(22) PCT Filed: Jan. 16, 2002
(86) PCT No.: PCT/FR02/00165

(30) Foreign Application Priority Data
Jan. 17, 2001 (FR) 01/00614

(51) Int. Cl. G21C 19/42

(52) U.S. Cl. 376/310

(57) ABSTRACT

A chemical etching solution in the form of jets (14) under pressure is put into contact with the radioactive substance fixed on the surface inside the hollow body (1), and the chemical etching solution that has come into contact with the radioactive substance is recovered and drained to outside the hollow body (1). The radioactive substance is in at least one of the following forms: a phase dissolved in the chemical etching solution; and particles detached from the metal surface by the jets (14) under pressure. The method and the apparatus of the invention serve to decontaminate the inside surface of the hollow body or a component placed inside the hollow body (1) which can be a cleaning vessel.

The invention relates to a method and apparatus for radioactive decontamination of a surface, in particular a metal surface, situated inside a hollow body.

In nuclear reactors, circuits or components are used that come into contact with radioelements, e.g. conveyed by an exchange fluid while the nuclear reactor is in operation.

For example, nuclear reactors cooled by pressurized water have a primary circuit in which the pressurized cooling water for the reactor that cools the fuel in the reactor core is set into circulation so as to come into contact in succession with the fuel assemblies of the core inside the nuclear reactor vessel, and with the heat exchange tubes of the steam generator. While circulating through the primary circuit, the pressurized cooling water picks up radioelements which are subsequently deposited in at least some portions of the primary circuit.

In particular, substances such as metal oxides containing radioelements are deposited on the inside surfaces of primary piping interconnecting the primary components of the reactor, and on the surfaces of the inside walls or components of the vessel or of the steam generators of the nuclear reactor.

When it is necessary to take action in the vicinity of a component, on a contaminated surface of the primary circuit, e.g. to perform an inspection, a repair, or to replace a component, the personnel taking the action needs to be protected against the ionizing radiation coming from the contaminated surfaces. It is then necessary to use biological protection that is expensive and that can be lengthy to install. Work performed in zones that are subject to radiation requires the personnel performing the action to wear special suits or requires remotely controlled automatic equipment to be used.

In all cases, the cost and the duration of such action are increased.

When taking action on contaminated components or piping, dismounting and dismantling components, or even when performing maintenance operations at regular intervals to eliminate deposited radioactive substances, proposals have been made to use decontamination methods by putting contaminated surfaces into contact with a chemical etching solution, e.g. a solution of nitric acid containing potassium permanganate, as described in FR-2 600 203.

In general, the surfaces contaminated by substances containing radioelements are the inside surfaces of components that are in the form of hollow bodies, such as the reactor vessel or the water chamber of a steam generator, or the piping, e.g. the large-diameter primary piping, or indeed the surfaces of components situated inside a hollow body such as a vessel or a pump body.

The chemical etching solution is then introduced into the hollow body and left in contact with the substances fixed on the contaminated surface for a sufficient length of time, or else it is put into circulation in contact with said substances, so that the substances return to the dissolved state in the etching solution which is either disposed of and eliminated at the end of the treatment, or else renewed inside the hollow body, e.g. by being recycled after regeneration.

Those operations generally require execution of long duration to ensure that decontamination is sufficiently complete and effective.

In some cases, parts of the primary circuit which are dismounted or cut away, such as segments or bends of piping or indeed portions of primary pumps for circulating the cooling water such as a pump wheel are decontaminated inside a cleaning tank into which the components for decontamination have been inserted together with a chemical etching solution which can be kept in contact with the component for a length of time that is sufficient to perform decontamination and then evacuated or put into circulation, optionally together with recycling and regeneration of the chemical solution.

When replacing one or more steam generators of a pressurized water nuclear reactor, it is necessary to cut up the primary piping for connection to the steam generator and then to weld the inlet and outlet tubes of the replacement steam generator to the cut and machined piping ends left ready to receive them. Prior to these operations it is necessary to decontaminate carefully the inside surfaces of certain pieces of piping which are generally accessible from one end only.

Such replacement operations which require the implementation of numerous means and the performance of numerous tasks in a specific order and using precise organization are much more satisfactory when associated with a length of downtime for the nuclear reactor that is as short as possible.

It is therefore most desirable to minimize the time required for performing the various tasks, and in particular decontamination.

In general, in any application, it is advantageous to use methods that are fast and effective for decontaminating the surfaces or components inside hollow bodies, such as piping, vessels, nuclear reactor water chambers, or cleaning tanks, by using means that are practical to implement and that are normally available on a nuclear reactor site.

The object of the invention is thus to propose a method of decontaminating a surface, in particular a metal surface, situated inside a hollow body, the surface having at least one substance containing a radioactive element fixed thereon, and being cleaned by causing the substance fixed thereon to come into contact with a chemical etching solution, enabling decontamination to be performed in a manner that is effective and fast using means that are simple, practical to implement, and easily available on the site of a nuclear power station.

To this end, the chemical etching solution is put into contact with the substance fixed on the surface inside the hollow body in the form of jets under pressure; and the chemical etching solution is recovered and removed to the outside of the hollow body after it has been put into contact with the radioactive substance together with the radioactive substance in at least one of the following forms: a phase dissolved in the chemical etching solution; and particles detached from the metal surface.

The invention also provides decontamination apparatus for implementing the method of the invention.

In order to make the invention well understood, there follows a description by way of example given with reference to the accompanying figures, relating to various implementations of the method and embodiments of the apparatus of the invention used for decontaminating piping or components of a primary circuit of a pressurized water nuclear reactor.

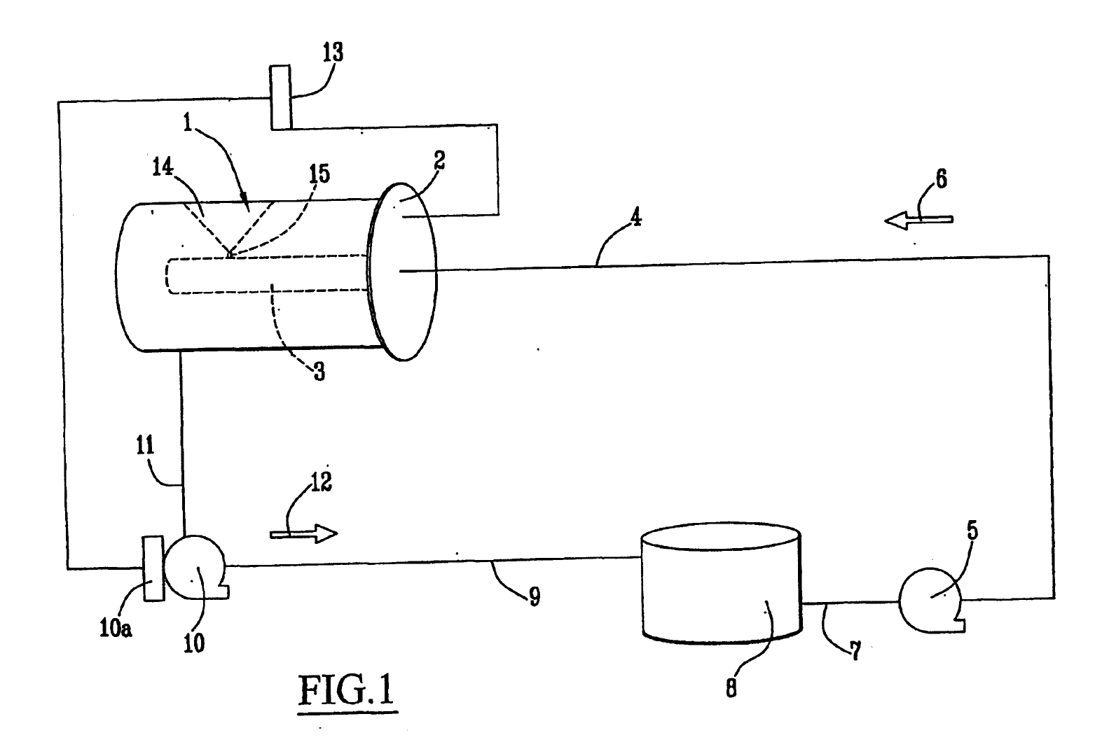

FIG. 1 is a diagrammatic view of a cleaning installation enabling the method of the invention to be implemented.

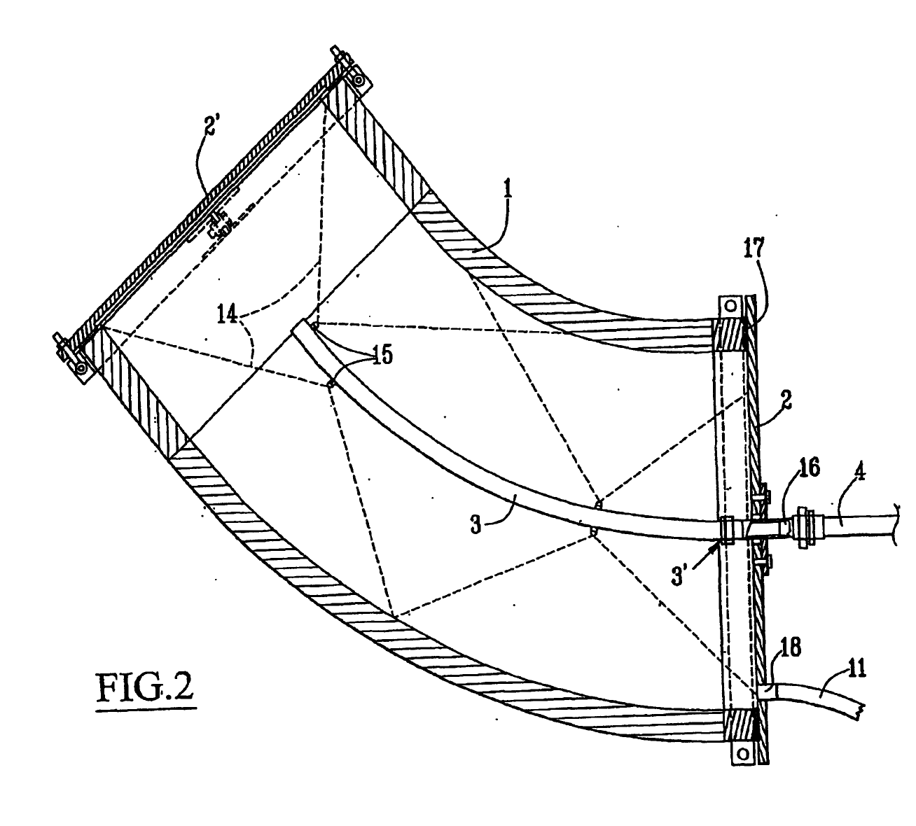

FIG. 2 is an axial section of a bend forming part of the primary piping of a nuclear reactor while it is being decontaminated by the method of the invention, in a first variant implementation.

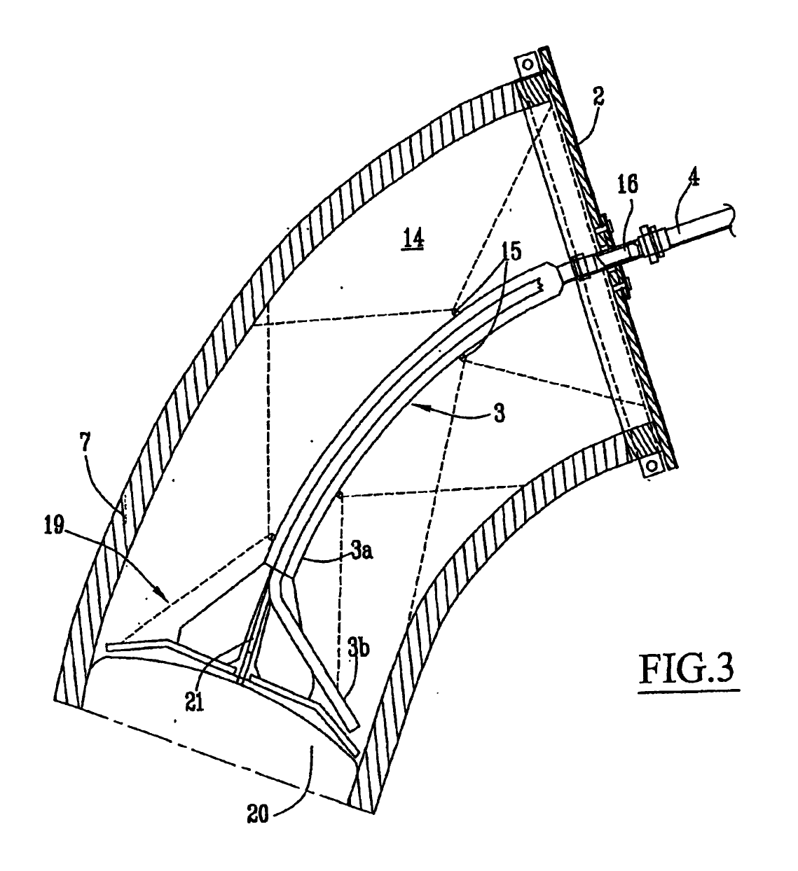

FIG. 3 is an axial section view of a bend of primary piping while it is being decontaminated using the method of the invention in a second variant implementation.

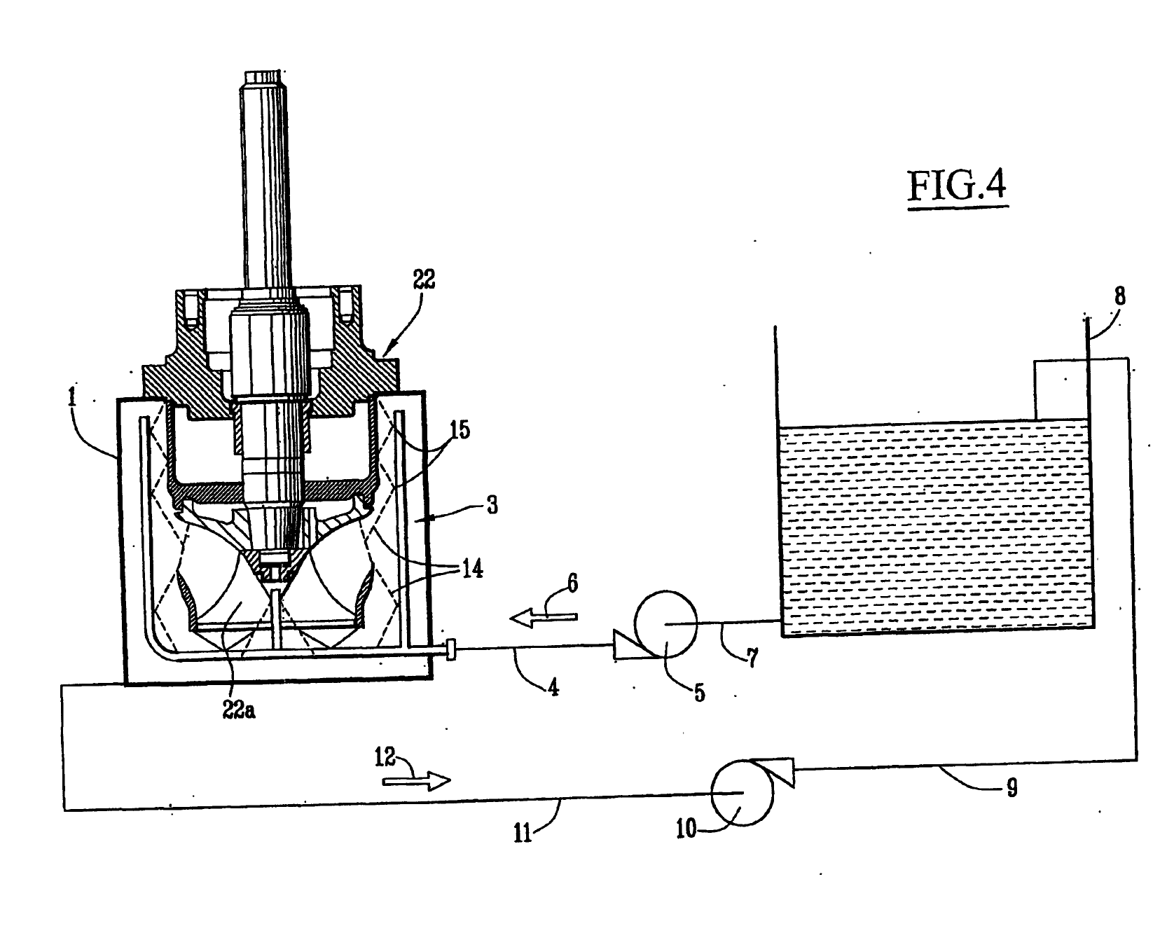

FIG. 4 is a diagrammatic elevation and fragmentary section view of an installation for decontaminating a primary pump wheel by means of the method of the invention.

FIG. 1 shows a hollow body 1 having at least one inside surface for decontamination, which surface can be the inside surface of the hollow body itself, for example. The hollow body 1 can be constituted, for example, by a segment of piping or by a receptacle such as a vessel whose inside surface is to be decontaminated before taking action.

The surface inside the hollow body 1 that is to be decontaminated can also be the surface of a component that is difficult or impossible to dismantle and that is left inside the hollow body 1. The hollow body 1 has a closed end and an open end on which a closure plate or stopper 2 is fitted, which can be secured in leaktight manner to the open end of the hollow body 1. A spray tube 3 is placed inside the hollow body, e.g. on an axial direction of the hollow body, the tube having a plurality of nozzles directed towards the surface to be cleaned, e.g. the inside surface of the hollow body 1.

The tube 3 is fed with cleaning and decontaminating fluid under pressure via piping 4 connected to the outlet portion of a high-pressure pump 5, so that high-pressure cleaning fluid travels along the piping 4 in the direction shown by arrow 6.

The inlet portion of the high-pressure pump 5 is connected via a connection pipe 7 to a tank 8 containing decontamination fluid.

The bottom portion of the tank 8 is connected to the pipe 7 while its top portion is connected to a connection pipe 9 for connecting the tank to the outlet portion of a recovery pump 10 whose inlet portion is connected by a connection pipe 11 to the inside volume of the hollow body 1, close to a low point of the hollow body 1. By way of example, the pump 10 can be a diaphragm pump enabling the decontamination fluid to be recovered from the bottom of the hollow body 1 and delivered to the tank 8 so as to enable it to be recycled and reused for decontaminating the hollow body, via the high-pressure pump 5.

Inside the tank 8, it is also possible to regenerate the decontamination fluid which is generally a chemical etching solution.

In its top portion, the closure plate 2 includes a tapping point to which a pressure gauge such as a water column gauge 13 is connected via a pipe to the inside volume of the hollow body 1. The pressure gauge 13 serves to measure the pressure inside the hollow body 1 and to provide a pressure signal to control means 10a for controlling the recovery pump 10 so as to adjust the flow rate of the recovery pump 10 to match that of the high-pressure pump 5.

The recovery pump can be constituted by a diaphragm pump, for example, and is suitable for running dry without being damaged, so that it is possible to adjust the flow rate of the recovery pump at will to match that of the high-pressure injection pump 5.

The high-pressure injection pump 5 delivers fluid to the tube 3 at a pressure which is higher than atmospheric pressure and which lies, for example, in the range 2 bars to 400 bars, so that the tube 3 with its nozzles 15 form jets 14 under pressure, each directed towards a zone of the surface to be cleaned inside the hollow body 1.

The decontamination fluid is a chemical reagent which can be in the form of a liquid, a gel, or a gas.

The chemical reagents can be acidic, basic, or neutral, oxidizing or reducing, and they can be used at ambient temperature or at a temperature higher than ambient. The reagents can be measured out and regenerated inside the storage tank 8; the tank 8 can have heater means, e.g. a resistance element, for raising the temperature of the decontamination fluid to a temperature higher than ambient, thereby increasing the reactivity of the fluid.

When a decontamination fluid is used that is constituted by a liquid chemical solution, the liquid is removed via a low point of the hollow body 1, either by using a recovery pump such as the pump 10 shown in FIG. 1, or else by allowing it to flow out under gravity, with the recovery tank then being disposed at a level that is lower than the level of the hollow body 1.

When the decontamination fluid is constituted by reagents in gel form, the reactive gel is sprayed inside the hollow body through the nozzles 15 of the tube 3 in the form of jets 14, and the body is then rinsed by spraying a liquid, generally water, onto the decontaminated surface and the rinsing liquid is removed by pumping.

Reagents and rinsing liquid are sprayed in the form of jets under pressure making it possible to detach contaminating substances containing radioelements from the surface to be cleaned by the mechanical action of the jet and by the chemical etching action of the reagent.

Depending on the type of reagent used, it is possible to use injection pressures in the tube and as supplied by the injection pump 5, that can be situated at any desired level within the range of pressures given above.

In order to start a decontamination operation, a chemical solution is prepared inside the storage receptacle 8, and in particular its reagent concentration is adjusted. The solution is made uniform and optionally raised to a desired temperature so as to obtain better reactivity on coming into contact with the surface to be decontaminated.

During decontamination, the recycled solution can be regenerated inside the tank 8.

The connection between the storage tank 8 and the hollow body 1 in which decontamination is being performed can be provided by flexible or rigid piping or by lines constituted by segments of flexible piping and segments of rigid piping.

The spray tube 3 can be constituted by a hollow section member whose section is of arbitrary shape (e.g. round, square, or hexagonal). The shape of the tube is matched to the shape of the surface to be decontaminated inside the hollow body. The tube is made of a material that is suitable for withstanding the reagent used for decontamination and also for withstanding the injection pressure.

The spray nozzles 15 of the tube 3 can be provided in such a manner that the jets 14 cover the entire surface that is to be decontaminated, and the jets 14 coming from the nozzles 15 can overlap without that harming in any way the effectiveness of the decontamination.

Two particular cases of cleaning the inside surface of a hollow body constituted by a bend for primary piping are described below with reference to FIGS. 2 and 3.

Corresponding items in FIG. 1 and in FIGS. 2 and 3 are given the same references.

In a first implementation, shown in FIG. 2, the hollow body 1 constituted by a bend for primary piping which has been cut off and machined at its ends is closed at a first end by a closure plate 2 having a central through opening in which a tapping point 16 is mounted for connecting the tube 3 to the piping 4 for feeding the tube 3 with decontamination liquid under pressure. The tube 3 is connected at a first end for fluid inlet via a coupling 3′ to an end portion of the tapping point 16 inside the hollow body 1. The end portion of the primary piping bend constituting the hollow body 1 that is remote from its end closed by the plate 2 is itself closed by a closure plate 2′ analogous to the plate 2 and having no central opening for passing a tapping point.

The closure plates 2 and 2′ are fitted against respective machined end surfaces of the bend 1 and they are clamped in place by mechanical means, e.g. screw and nut means with a sealing gasket being interposed such as the gasket 17 which is interposed between the plate 2 and the first end of the bend 1.

A second tapping point 18 passes through the closure plate 2 in a zone situated in the bottom of the hollow body 1.

When the tube 3 is fed with fluid under pressure, the nozzles 15 form jets 14 each covering a portion of the inside surface of the bend 1.

The tube 3 can be curved in a manner analogous to the bend 1, so that the axis of the tube coincides with the axis of the bend 1. The nozzles 15 are distributed along the length of the tube 3 and are oriented in such a manner that the jets 14 can cover all of the inside surface of the bend 1, and adjacent jets can also present overlap zones.

The jets under pressure which strike the inside surface of the hollow body 1 act both mechanically and chemically to detach radioactive substances that have become deposited on the inside surface of the bend 1, i.e. substances that contain at least one radioelement.

Part of the deposited radioactive substances can also be dissolved in the etching reagent.

The etching reagent containing the particles that have been detached and the substances that have been dissolved collects in the bottom portion of the hollow body 1 and is removed via the tapping point 18 and the drain pipe 11 optionally connected to a recovery pump.

In a second implementation of a method of cleaning a primary piping bend 1, the bend is accessible only via an inlet opening that has been machined, with the closure plate 2 being fixed on the inlet opening and with the tube 3 being connected to the tapping point 16 that passes through the central portion of the closure plate 2. The tube 3 extending along the axis of the bend 1 comprises an outer tube 3a having spray nozzles 15 fixed thereto and an inner tube 3b which is mounted coaxially inside the tube 3a (FIG. 3).

The outer tube 3a communicates at an open first end with a decontamination fluid manifold fed via the tapping point 16 and the pipe 4, and at its opposite end which is closed it carries a unit 19 for closing the second end of the bend 1.

The closure unit 19 includes an inflatable plug 20 fed with gas under pressure from outside the bend 1 via a pipe 21 running along the tube 3.

The inner tube 3b of the tube 3 has a first end portion connected to a drain pipe via the closure plate 2, and a second end portion which is open and which is placed close to the top surface of the closure unit 19 which includes a rigid assembly for supporting the inflatable plug 20.

To put the tube 3 into place inside the primary piping bend that is accessible via an open first end only, the closure unit 19 is engaged with the plug 20 in the deflated state, and the plug 20 is inflated only once it is in position. Thereafter the tube 3 is put into place inside the bend so as to cause the closure plate 2 to bear against the first end of the bend 1.

The closure plate is fixed to the first end of the bend 1 by mechanical means and the inflatable plug 20 is inflated so as to ensure that it closes the second end of the bend 1 in leaktight manner, with the inside surface of the bend being cleaned by the tube between the first end as closed by the plate 2 and the second end as closed by the inflatable plug 20.

The decontamination fluid delivered into the peripheral annular space of the tube 3 between the tubes 3a and 3b is delivered via the nozzles 15 in the form of pressurized cleaning jets 14 covering the entire inside surface of the bend 1. The decontamination fluid containing particles of radioactive substances that have been detached from the inside surface of the bend 1, or dissolved substances, is recovered via the tube 3b which is connected to a suction installation such as a recovery pump.

The apparatus shown in FIGS. 2 and 3 can be used equally well for decontaminating bends, as described above, and for decontaminating rectilinear segments of primary piping.

FIG. 4 shows a decontamination installation used for decontaminating the hydraulic portion of a primary pump that has a removable assembly 22 constituted by the pump wheel 22a, a drive shaft for the pump wheel, and a thermal barrier that receives seals.

The pump wheel 22a and the casing of the thermal barrier which comes into contact with the primary water of the nuclear reactor while the reactor is in operation can be covered in radioactive substances such as oxides which deposit on the pump wheel and on a support portion while the nuclear reactor is in operation.

After the hydraulic portion of the pump has been operating for a certain length of time in the primary circuit of the nuclear reactor, it needs to be overhauled, and in order to be able to take action thereon it is necessary for it to be decontaminated. Such decontamination using the method of the invention cannot be implemented inside the pump body because there is no room to insert one or more spray tubes inside the pump body.

FIG. 4 shows an insulation for decontaminating the hydraulic portion of the pump: items shown in FIG. 4 that perform functions analogous to items shown in the apparatus of FIGS. 1 to 3 are given the same references.

In particular, the installation comprises a hollow body 1 constituted by a vessel containing a set of spray tubes 3, having nozzles 15 directed towards the central portion of the cleaning vessel 1 where the axis of the pump shaft is located.

The vessel 1 has a top edge supporting the thermal barrier 22 in such a manner that the portion of the pump to be cleaned comprising the pump wheel 22a and the casing of the thermal barrier is looking towards the nozzles 15 of the tubes 3.

It is possible to use a set of tubes 3 comprising a plurality of component tubes placed parallel to the axis of rotation of the pump wheel, around the pump and the casing of the thermal barrier.

It is also possible to use one or two tubes only of a set of tubes 3 and to cause the pump wheel and the thermal barrier to rotate about the axis of the pump wheel during cleaning.

The decontamination installation includes a facility 8 for storing decontamination reagents, a high-pressure pump 5 for injecting decontamination fluid under pressure from the facility 8 into the set of tubes 3, and a recovery pump 10 connected to the bottom or drain portion of the vessel 1 via piping 11 and to the storage facility via a return pipe 9.

The installation operates in the same manner as the installations described above.

Decontamination fluid under pressure is delivered by the high-pressure pump 5 into the set of tubes 3, as represented by arrow 6, such that the jets 14 formed by the tubes in the set of tubes come into contact with all of the outside surfaces of the pump wheel 22a and of the thermal barrier casing. The jets 14 under pressure act mechanically to detach particles of radioactive substances from the various portions of the outside surface of the pump wheel, and they also dissolve the radioactive substances chemically.

The decontamination fluid recovered from the bottom of the cleaning vessel 1 via the drain pipe 11 contains particles of radioactive substances and certain radioactive species in dissolved form in the reagents of the decontamination fluid.

The decontamination fluid recovered from the bottom of the cleaning vessel 1 can be filtered prior to being reintroduced into the storage tank 8.

The tubes in the set of spray tubes 3 are disposed in such a manner as to make it possible to reach all of the portions of the outside surface of the pump wheel and of the casing of the thermal barrier.

Naturally, an installation as shown in FIG. 4 can be adapted to decontaminate other types of primary component of a nuclear reactor.

The tubes can be changed in order to adapt them to the shape of a component for decontamination, or the entire cleaning vessel 1 can be changed.

The main advantages of the method and apparatus of the invention are as follows:

The effectiveness of decontamination is improved by combining mechanical action with chemical action. The chemical reagents serve to weaken layers of radioactive substances, e.g. oxide layers, by dissolving elements making up these layers. The mechanical action of the jets under pressure serves to detach the layers that have been weakened by chemical etching. This provides access for the chemical etching solution to adjacent oxide layers.

Permanently renewing the chemical decontamination solution that comes into contact with the surface to be decontaminated serves to improve the effectiveness of decontamination. Decontamination effectiveness is linked to the thickness of the diffusion layer of the etching solution and thus to the speed of the fluid.

The volume of solution used is reduced, thereby reducing the amount of waste produced while cleaning. The volume of etching solution needed is that which suffices to ensure that the high-pressure pump can operate without becoming unprimed and without cavitation. This volume is generally much smaller than the volume that would be required to fill completely the hollow body containing the surface that is to be decontaminated.

The outside portion of a hollow body whose inside surface is to be decontaminated remains completely free of radioelements coming from the surface that is to be decontaminated because there is no contact between the decontamination chemical solutions and the outside surface of the hollow body.

Handling and installation of the tooling is made easier and requires smaller hoist means.

It is easy with minor alternations to transform a conventional type of decontamination installation having a circuit for circulating the chemical reagent liquid. In general, it suffices to install a high-pressure pump for spraying the chemical reagent liquid and possibly also a recovery pump for draining the fluid from a hollow body in which decontamination is performed.

There is no risk of solution overflowing because the hollow body is closed and this can be done in leakproof manner.

The personnel performing decontamination is subjected to low dosages because of the speed with which the tooling required for decontamination can be put into position.

The closure plate which is put into place on the hollow body can be made leakproof in simple manner.

The invention is not limited to the embodiments described above.

In some cases, it is possible to use telescopic tubes making it possible to reach portions of the surface to be decontaminated that are remote from the inlet opening of the hollow body, or a tube provided with a rotary head at its end, or a tube that is provided with devices comprising arms and nozzles that are set into rotation by reaction when the fluid under pressure is ejected through the nozzles. This makes it possible to spray chemical reagents tangentially relative to the surface to be decontaminated.

It is possible to provide removable tubes so as to be able to decontaminate components of different shapes.

When the hollow body is not symmetrical about an axis, it is possible to use a plurality of tubes mounted on a common closure plate so as to enable jets to be sprayed onto surfaces of complex shape belonging to the component that is to be decontaminated.

In general, the invention can be applied in numerous domains in the nuclear industry.

1/ A method of decontaminating a surface of a component (7, 22), in particular a metal surface, used in the nuclear industry, the surface having at least one substance containing a radioactive element fixed thereon, and being cleaned by causing the substance fixed thereon to come into contact with a chemical etching solution, inside a hollow body (1, 7), the method being characterized by the facts that: the chemical etching solution is put into contact with the substance fixed on the surface to be decontaminated in the form of a plurality of jets (14) under pressure produced by a plurality of nozzles (15) secured to at least one tube (3) mounted in a fixed position relative to the surface to be decontaminated inside the hollow body (1, 7), and having a shape adapted to the shape of the surface to be decontaminated, in such a manner that the jets (14) cover the entire surface to be decontaminated and detach the radioactive substance from the surface to be contaminated by mechanical jet action and by chemical etching action, with the liquid chemical etching solution that comes into contact with the surface to be decontaminated being continuously renewed; and the chemical solution is removed to the outside of the hollow body after it has been put into contact with the radioactive substance together with the radioactive substance in at least one of the following forms: a phase dissolved in the chemical etching solution; and particles detached from the metal surface.

2/ A method according to claim 1, characterized by the fact that the surface to be decontaminated is an inside surface of the component (7) constituting the hollow body (7), the jets under pressure constantly cover the entire inside surface of the hollow body (7) to be decontaminated, possibly with the jets (14) overlapping one another.

3/ A method according to claim 2, characterized by the fact that the surface to be decontaminated is an inside surface of a segment of pipe (7) or a bend of the primary circuit of a pressurized water nuclear reactor that is accessible via one or both opposite ends.

4/ A method according to any one of claims 1 to 3, characterized by the fact that the hollow body (1) is defined by a cleaning vessel and the outside surface of a component (22, 22a) placed inside the cleaning vessel (1).

5/ A method according to any one of claims 1 to 4, characterized by the fact that the chemical etching solution contains at least one of the following chemical reagents: acid reagents; basic reagents; neutral reagents; oxidizing reagents; and reducing reagents.

6/ A method according to any one of claims 1 to 5, characterized by the fact that the temperature of the chemical reagents is raised to a temperature suitable for improving the reactivity of the chemical etching solution.

7/ A method according to any one of claims 1 to 6, characterized by the fact that the chemical etching solution recovered after coming into contact with the radioactive substance is recycled, optionally after being regenerated.

8/ Apparatus for decontaminating a surface, in particular a metal surface, of a component (7, 22) used in the nuclear industry, the surface having fixed thereon at least one substance containing at least one radioactive element and being cleaned by putting the substance that is fixed on the surface into contact with a chemical etching solution, inside a hollow body (1, 7), the apparatus comprising a storage tank (8) connected to a circuit for circulating the chemical etching solution and that communicates with the inside of the hollow body (1, 7), the apparatus being characterized by the facts that it comprises at least one tube (3) including a plurality of nozzles (15), the tube being mounted in a fixed position relative to the surface to be decontaminated inside the hollow body (1, 7), and having a shape adapted to the shape of the surface to be decontaminated, the plurality of nozzles (15) being disposed so as to form a plurality of jets (14) covering the entire surface to be decontaminated, and that the circuit (4, 7, 9, 11) includes piping (4) for feeding the chemical etching solution under pressure to the tube (3) from a storage tank (8) via a high-pressure pump (5), and piping (11, 9) for removing the chemical etching solution after it has been put into contact with the radioactive substance and for returning it to the storage tank (8) via a recovery pump (10).

9/ Apparatus according to claim 8, when the hollow body (1) is a segment of pipe or a bend of the primary circuit of a pressurized water nuclear embodiment and the surface to be contaminated is the inside surface of the segment of pipe or bend, the apparatus being characterized by the fact that it includes a closure plate (2) for closing the segment or bend of the primary pipe at a first end in leakproof manner, a spray tube (3) being fixed to the plate and connected to the piping (4) for feeding the chemical etching solution under pressure via a tapping point (16) passing through the closure plate (2), the tube (3) extending substantially along an axis of the segment or bend of the primary pipe (1) and carrying nozzles (15) directed towards the inside surface of the segment or bend of the primary circuit pipe (1).

10/ Apparatus according to claim 9, characterized by the fact that it includes a second closure plate (2′) for closing a second end of the segment or bend of the primary circuit pipe (1).

11/ Apparatus according to claim 9, characterized by the fact that the tube (3) carries, at a second end opposite from its end connected to the tapping (16) passing through the first closure plate (2), a closure unit (19) including an inflatable plug (20) and a duct (21) for feeding the inflatable plug with gas under pressure from outside the hollow body (1).

12/ Apparatus according to claim 11, characterized by the facts that the tube (3) is constituted by two coaxial tubes (3a, 3b), an outer tube (3a) carrying nozzles (15) for forming jets (14) of etching solution under pressure, and an inner tube (3b) co-operating with the outer tube (3a) to define an annular space that is closed at the second end of the tube (3) remote from the closure plate (2) and connected to a manifold for feeding etching liquid solution under pressure, and that the inner tube (3b) of the tube (3) projects from the closed second end of the peripheral annular space of the tube (3) to open out via an open end adjacent to the closure unit (19).

13/ Apparatus according to claim 8, characterized by the fact that the hollow body (1) is a cleaning vessel for receiving a component (22, 22a) internally, facing at least one tube (3) for spraying jets of chemical etching solution.

14/ Apparatus according to any one of claims 8 to 13, characterized by the fact that the recovery pump (10) is controlled via a control unit (10a) receiving a signal from a pressure gauge (13) measuring the pressure inside the hollow body (1).
